(19) United States
(12) Patent Application Publication
(10) Pub. No.: US 2014/0297739 A1
(43) Pub. Date: Oct. 2, 2014

(54) Media Previews Based on Social Context

(71) Applicants: Howard T. Stein, Santa Monica, CA (US); Christopher R. Gomersall, Playa Vista, CA (US)

(72) Inventors: Howard T. Stein, Santa Monica, CA (US); Christopher R. Gomersall, Playa Vista, CA (US)

(21) Appl. No.: 13/851,781

(22) Filed: Mar. 27, 2013

(51) Int. Cl. H04L 29/08

(52) U.S. Cl. CPC H04L 67/22
USPC 709/204

(57) ABSTRACT

In one embodiment, a method includes querying a social graph of a social-networking system for social content associated with one or more users of the social-networking system and accessing a selection by a user of one or more entities on which displayed media content is to be based. The method further includes determining, using the social content, recommended media content according to the selected one or more entities and providing the recommended media content for display on a display device. The social graph includes multiple nodes and edges connecting the nodes, the nodes including user nodes that are each associated with a particular user of the social-networking system.

### TECHNICAL FIELD

This disclosure generally relates to social networking and more specifically to providing media previews based on social context.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Particular embodiments enhance a user's media viewing experience by providing recommended media previews which may be displayed on a mobile device, a personal computer, or any other display device. The media previews are previews of media content such as movies, TV shows, games, and the like and are provided based on social context. The media previews provide an easy and convenient way for a user of a social-networking system to view short previews (such as movie trailers) based on what the user likes, based on what the user's friends like, or based on what all users of the social-networking system like.

In certain embodiments, media previews are displayed as recommended media content on a landing page. The landing page may be, for example, an application (“app”) running on a smartphone. The landing page may display the media previews in order of interest to the user, the user's friends, or other users of the social-networking system. In some embodiments, social content may be displayed in close proximity to the media previews on the landing page. The social content may include, for example, a number of friends who have watched the media preview, a number of other users who have watched the preview, a number of users who have “liked” the preview, a number of users who have shared the preview, and the like. In certain embodiments, users may select various user selectable options in response to viewing media previews. For example, a user may select an option to “like” the media preview, an option to comment on the media preview, an option to indicate that the user viewed full-length media content associated with the media preview, an option to purchase one or more tickets to view full-length media content associated with the media preview, and the like.

### BRIEF DESCRIPTION OF THE DRAWINGS

FIG. 1 illustrates an example network environment associated with a social-networking system, according to certain embodiments.

FIG. 2 illustrates an example social graph, according to certain embodiments.

FIG. 3 illustrates an example newsfeed that includes media preview posts, according to certain embodiments.

FIG. 4 illustrates an example media previews landing page, according to certain embodiments.

FIG. 5 illustrates an example method for providing media previews, according to certain embodiments.

FIG. 6 illustrates an example computer system, according to certain embodiments.

### DESCRIPTION OF EXAMPLE EMBODIMENTS

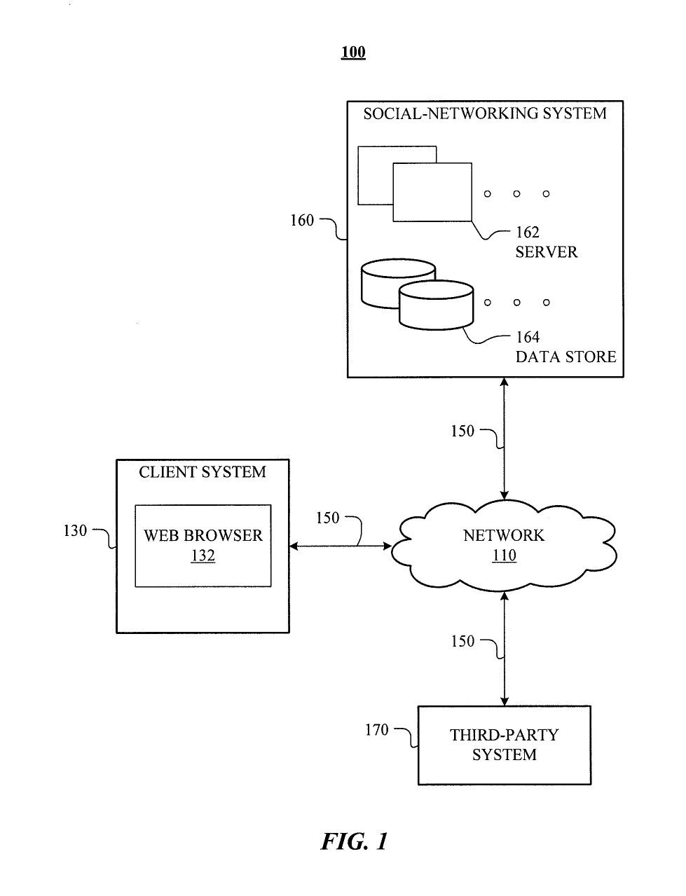

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 164 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 whom they want to be connected to. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

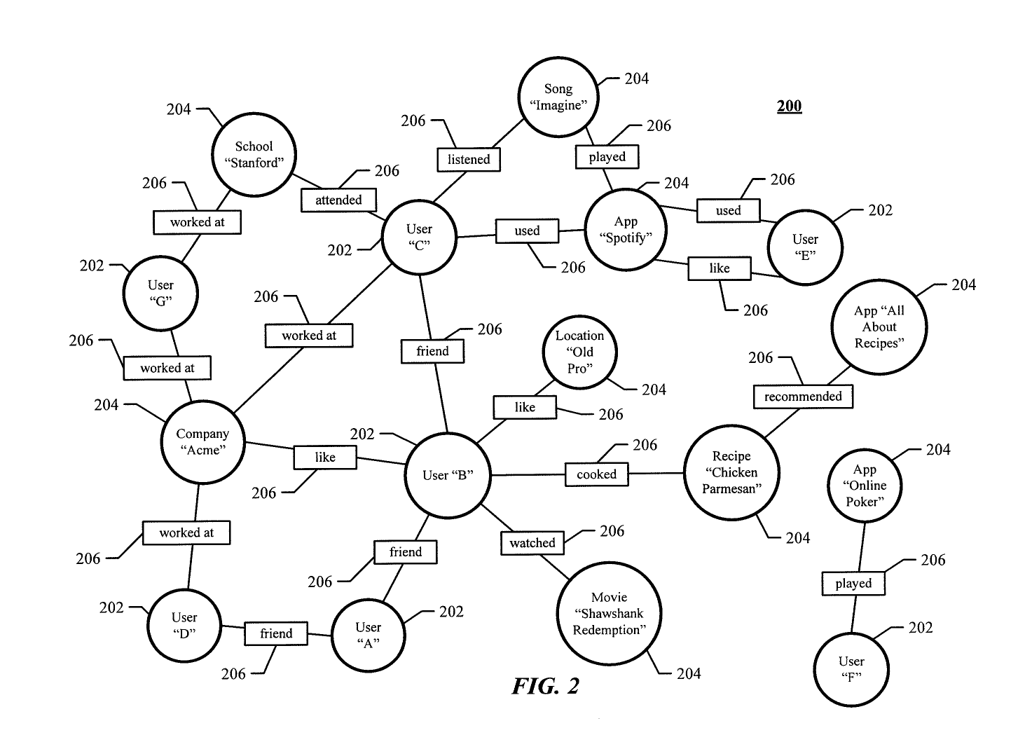

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 130 to send to social-networking system 160 a message indicating the user's action. In response to the message, social-networking system 160 may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 164. In the example of FIG. 2, social graph 200 includes an edge 206 indicating a friend relation between user nodes 202 of user “A” and user “B” and an edge indicating a friend relation between user nodes 202 of user “C” and user “B.”Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 160). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 160 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 160) or RSVP (e.g., through social-networking system 160) to an event associated with the advertisement. In addition or as an alternative, an advertisement may include social-networking-system context directed to the user. As an example and not by way of limitation, an advertisement may display information about a friend of the user within social-networking system 160 who has taken an action associated with the subject matter of the advertisement.

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 170, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 170, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example and not by way of limitation, if a user may make frequently posts content related to “coffee” or variants thereof, social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 200, social-networking system 160 may analyze the number and/or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 160 may determine that the user has a higher coefficient with respect to the first photo than the second photo because having a tagged-in-type relationship with content may be assigned a higher weight and/or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

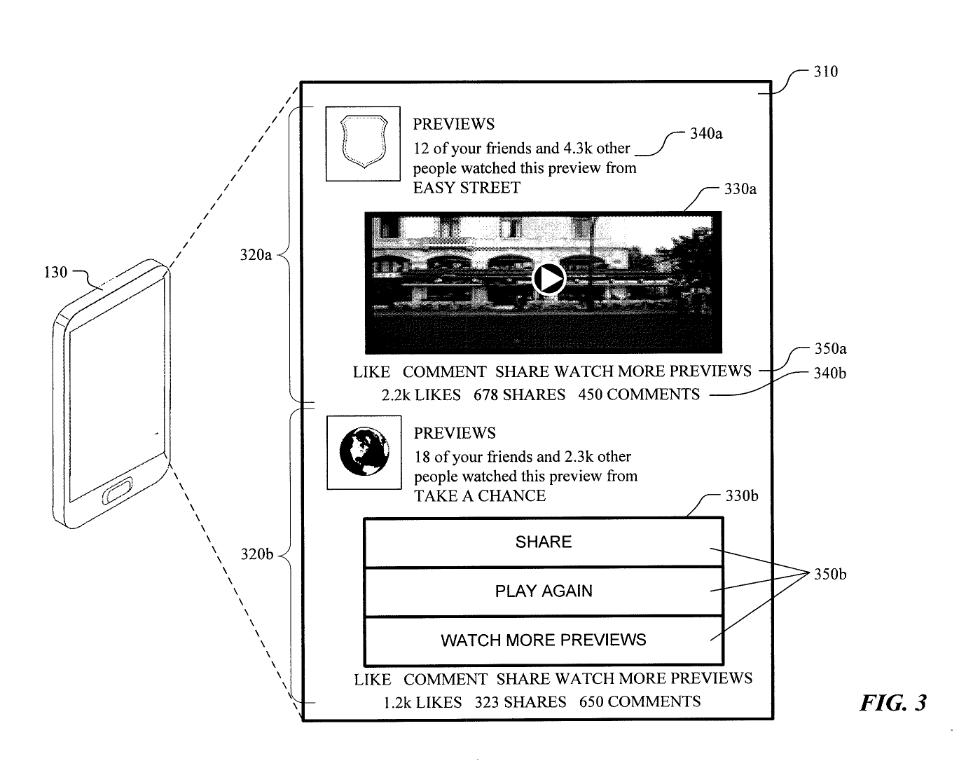

FIG. 3 illustrates an example newsfeed 310 which may be displayed on mobile device 130 or any other client system 130. In general, newsfeed 310 is generated by social-networking system 160 using social graph 200 and is a personalized set of content objects to display to a user. For example, newsfeed 310 may include an aggregation of stories, posts, status updates, photos, and sponsored content of other users or entities connected to the user.

Newsfeed 310 includes two posts 320 (i.e., posts 320a-b). Each post 320 in this example embodiment includes a media preview 330, social content 340, and one or more user selectable options 350. The social content 340 near or proximate each media preview 330 is related to the media preview 330 and is generated by social-networking system 160 using social graph 200.

Media previews 330 are any video content associated with other full-length media content. For example, media previews 330 may be shortened video clips of full-length movies, TV shows, video games, or any other media content. Media previews 330 may be selected by a user (e.g., clicked with a computer mouse or touched with a finger) in order to begin playing the media preview 330. In some embodiments, media preview 330 appears initially as an image which may be an image captured from video associated with the media preview 330. For example, if a particular media preview 330 is a preview of a movie, the particular media preview 330 may initially appear in newsfeed 310 as an image captured from the movie. As another example, if a particular media preview 330 is a preview of a video game, the particular media preview 330 may initially appear in newsfeed 310 as an image captured from actual gameplay of the game.

In some embodiments, the image that represents a media preview 330 is a cover image provided by an entity associated with the media content of the media preview 330. For example, if a particular movie studio uploads to social-networking system 160 a preview of a movie produced by the movie studio, the movie studio may provide or otherwise indicate to social-networking system 160 a particular image to use as a cover image for the movie. Social-networking system 160 may then access the cover image and use it to represent a media preview 330 for the movie in newsfeed 310. As another example, if a particular game developer uploads to social-networking system 160 a preview of a game produced by the developer, the developer may provide or otherwise indicate to social-networking system 160 a particular image to use as a cover image for the game. Social-networking system 160 may then access the cover image and use it to represent a media preview 330 for the game in newsfeed 310.

Social content 340 is any social content associated with media previews 330 that is determined by social-networking system 160 from social graph 200. In some embodiments, social content 340 may include an indication of how many other users of social-networking system 160 have viewed, “liked,” shared, or posted comments about media preview 330. As a specific example, consider the example post 320a of FIG. 3. In this example, media preview 330a is a preview of a movie titled “EASY STREET.” Social-networking system 160 may query social graph 200 and determine that twelve of the user's friends and over 4,300 other users of social-networking system 160 have viewed media preview 330a for “EASY STREET.” Social content 340a, which reads “12 of your friends and 4.3 k other people watched this preview from EASY STREET,” may them be generated and displayed proximate to media preview 330a. In addition, social-networking system 160 may query social graph 200 and determine that over 2,200 other users have “liked” media preview 330a, that 678 other users have shared media preview 330, and that 450 comments have been posted about media preview 330a. Social content 340b, which reads “2.2 k LIKES 678 SHARES 450 COMMENTS,” may then be generated and displayed proximate to media preview 330a.

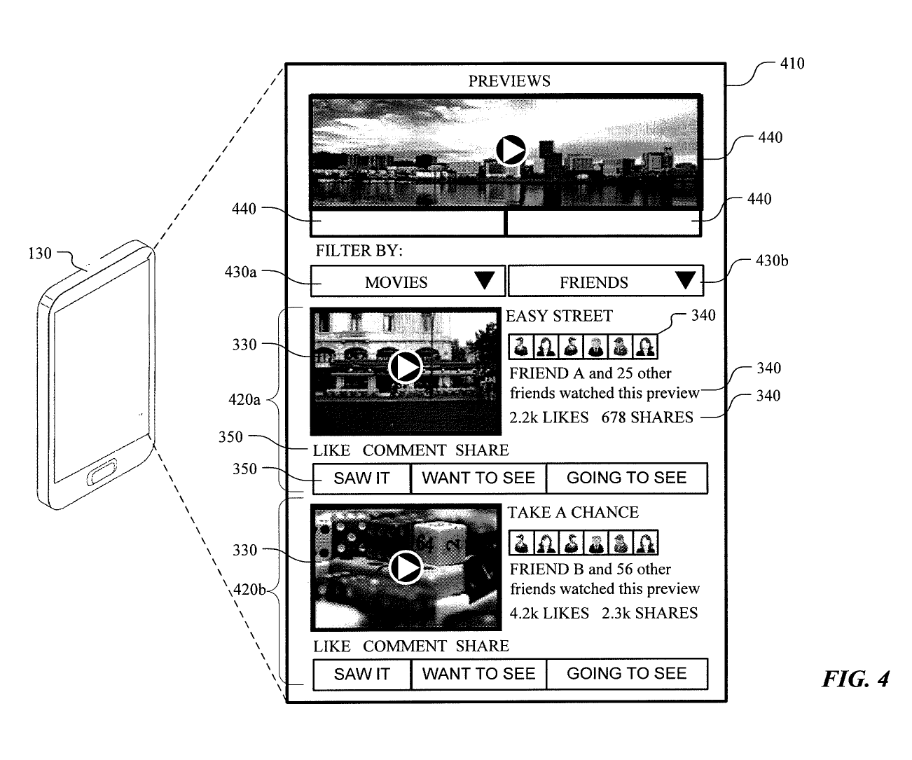

User-selectable options 350 are any options that permit a user to perform one or more actions associated with media preview 330. For example, user-selectable options 350a may include options that the user may select to indicate that he “likes” media preview 330a, to comment about media preview 330a, and to share media preview 330a. Once selected, user selectable-options 350 may cause any appropriate action within social-networking system 160. For example, if a user selects user selectable-option 350a to “like” media preview 330a, an edge 206 may be added to social graph 200 to indicate that the user “likes” media preview 330a. As another example, if a user selects user selectable-option 350a to “share” media preview 330a, a post may appear in the user's friends' newsfeed indicating that the user has shared media preview 330a. In some embodiments, if a user selects user selectable-option 350a to “WATCH MORE PREVIEWS,” a media previews landing page such as media preview landing page 410 discussed below in reference to FIG. 4 may be launched or otherwise displayed.

In some embodiments, media previews 330 may display one or more user-selectable options 350 at the conclusion of playing a video. For example, FIG. 3 illustrates three user-selectable options 350b that appeared after a user selected and viewed media preview 330b. As illustrated, user-selectable options 350b include options to share media preview 330b, to play media preview 330b again, and to watch more previews. In some embodiments, the “WATCH MORE PREVIEWS” user selectable option 350 may launch or otherwise display a media previews landing page such as media preview landing page 410 discussed below in reference to FIG. 4.

FIG. 4 illustrates an example media previews landing page 410 which may be displayed on mobile device 130 or any other client system 130. In general, the content of media previews landing page 410 is generated by social-networking system 160 using social graph 200. Media previews landing page 410 provides a personalized set of media previews 330 for display to a user. Media previews landing page 410 may include user filter selections 430, sponsored items 440, and multiple recommended media content 420 (i.e., 420a-420b) that may be displayed in order of interest. Each recommended media content 420 may include a media preview 330, social content 340, and user selectable options 350. Media preview landing page 410 in some embodiments is an app or is visually similar to an app running on client system 130.

Media previews landing page 410 provides a user with a personalized set of media previews 330 that are based on relevant interests and social context. For example, social-networking system 160 may analyzing social graph 200 for a particular user and determine multiple media previews 330 that may be of interest to the user. The determined media previews 330 for the user may then be displayed in media preview landing page 410 as recommended media content 420. More details about how social content 340 for recommended media content 420 is determined by social-networking system 160 are discussed in more detail below. The user may scroll through the recommended media content 420 and select any media preview 330 to view. In addition, social content 340 and user selectable options 350, as discussed above in reference to FIG. 3, may be displayed proximate to media previews 330 and may allow the user to view social data about and interact with the media preview 330.

In some embodiments, one or more user filter selections 430 are provided on media preview landing page 410. Some embodiments may include one or both of user filter selections 430a and user filter selections 430b, or any other appropriate media filter. User filter selections 430a are any appropriate filters for controlling what type of recommended media content 420 is displayed. For example, user filter selections 430a may allow the user to select between movies, TV shows, games, and the like. Social-networking system 160 may access user filter selection 430a selected by the user and then display only the selected media type for media previews 330 in recommended media content 420. For example, if the user selected movies using user filter selections 430a, only media previews 330 of movies will be determined using social graph 200 by social-networking system 160 and then displayed in recommended media content 420.

User filter selections 430b are any appropriate filters for controlling what entities of social-networking system 160 the recommended media content 420 is based upon. In some embodiments, the choice of entities may include the user, the user's friends, or all users of social-networking system 160. For example, user filter selections 430b may allow the user to select between displaying recommended media content 420 that is based on the user's likes and interests (e.g, “ME”), displaying recommended media content 420 that is based on the user's friends' likes and interests (e.g, “FRIENDS”), or displaying recommended media content 420 that is based on the likes and interests of all users of social-networking system 160 (e.g, “EVERYONE”). Social-networking system 160 may access user filter selection 430b selected by the user and then display media previews 330 in recommended media content 420 that are based on the selection. For example, if the user selected “FRIENDS” for user filter selections 430b, media previews 330 based on the likes and interests of the user's friends will be determined using social graph 200 by social-networking system 160 and then displayed in recommended media content 420. Determining media previews 330 for recommended media content 420 using social graph 200 is discussed in more detail below.

Recommended media content 420 may include any social content 340 proximate to media preview 330. For example, recommended media content 420 may include an indication of a number of other users of social-networking system 160 who have viewed the media preview 330, an indication of a number of other users of social-networking system 160 who have “liked” the media preview 330, an indication of a number of other users of social-networking system 160 who have shared the media preview 330, or an indication of a number of comments about the media preview 330. In some embodiments, recommended media content 420 may also include a facepile 340. Facepile 340 may include, for example, images, icons, or avatars of other users (e.g., friends) of social-networking system 160 who have viewed the media preview 330, as determined using social graph 200.

Recommended media content 420 may also include any user selectable option 350 proximate to media preview 330. As discussed above, user selectable options 350 may include an option to “like” the displayed media preview 330, an option to comment on the displayed media preview 330, and an option to share the media preview 330. In some embodiments, user selectable option 350 may also include an option to indicate that the user viewed full-length media content associated with the media preview 330 (i.e, “SAW IT”), an option to indicate that the user desires to view full-length media content associated with the media preview 330 (i.e., “WANT TO SEE IT”), an option to indicate that the user is planning to view full-length media content associated with the media preview 330 (i.e., “GOING TO SEE IT”), and an option to purchase one or more tickets to view full-length media content associated with the media preview 330.

In some embodiments, media preview landing page 410 may include one or more sponsored items 440. Sponsored items 440 may be a media preview 330 that an entity of social-networking system 160 paid to display to all users of social-networking system 160 in media preview landing page 410. For example, a movie studio may pay social-networking system 160 to display a media preview 330 for a movie that is to be released in the future. As another example, a TV network may pay social-networking system 160 to display a media preview 330 for an upcoming TV show episode, season, or series. In some embodiments, sponsored item 440 may include an advertisement. While FIG. 4 depicts a certain location and number of sponsored items 440 on preview landing page 410, other embodiments may include any number and configuration of sponsored items 440.

In operation, social-networking system 160 determines recommended media content 420 from social graph 200 for display to a user on a display device such as client system 130. In general, recommended media content 420 may be determined based on interests and social context using information from social graph 200. To do so, social-networking system 160 queries social graph 200 for information associated with one or more users of the social-networking system. Once the information from social graph 200 is obtained, social-networking system 160 utilizes the information and user filter selections 430 to determine recommended media content 420. Determining recommended media content 420 based on user filter selections 430 is discussed in more detail below.

If a user has selected user filter selection 430b to display recommended media content 420 based on himself (i.e., user filter selection 430b of “ME”), social-networking system 160 queries social graph 200 for information associated with the user and utilizes the social graph information to determine recommended media content 420 based on the user. The information associated with the user may include, for example, content uploaded by the user, postings by the user, “likes” of the user, chatter by the user, and the like. For example, if the user has posted content to social-networking system 160 about an upcoming movie (e.g., created posts about the movie, etc.), a trailer for that movie may appear as media preview 330 in recommended media content 420 for the user.

If a user has selected user filter selection 430b to display recommended media content 420 based on the user's friends (i.e., user filter selection 430b of “FRIENDS”), social-networking system 160 queries social graph 200 for information associated with the user's friends and utilizes the social graph information to determine recommended media content 420 based on the friends. For example, if one or more friends (or a certain percentage of friends) of a user have “liked” a certain media preview 330, the media preview 330 may appear as recommended media content 420 for the user. As another example, if friends of the user have posted content to social-networking system 160 about an upcoming movie (e.g., created posts about the movie, etc.), a trailer for that movie may appear as media preview 330 in recommended media content 420 for the user.

If a user has selected user filter selection 430b to display recommended media content 420 based on all users of social-networking system 160 (i.e., user filter selection 430b of “EVERYONE”), social-networking system 160 queries social graph 200 for information associated with all users of social-networking system 160 and utilizes the social graph information to determine recommended media content 420 based on all users. For example, media previews 330 having the greatest amount of “likes” by all users of social-networking system 160 may appear as recommended media content 420. As another example, media previews 330 having the greatest amount of views among all users of social-networking system 160 may appear as recommended media content 420. In some embodiments, recommended media content 420 may appear in descending order in media preview landing page 410 based on the number of “likes” or total views (i.e., media preview 330 having the largest total view count by all users of social-networking system 160 may appear at the top, the second-most views may appear next, and so forth).

In certain embodiments, social networking system 160 may utilize social coefficients to determine media previews 330 for recommended media content 420. Some embodiments may utilize coefficients as described in U.S. patent application Ser. No. 12/978,265 entitled “Contextually Relevant Affinity Prediction in a Social Networking System,” which is incorporated herein by reference. Social networking system 160 may utilize the following information from social graph 200 in determining coefficients of specific media previews 330 for an individual user:
the number of friends of the user who have liked the specific media preview 330
the total number of users of social networking system 160 who have liked the specific media preview 330
the number of friends of the user who have viewed the specific media preview 330
the total number of users of social networking system 160 who have viewed the specific media preview 330
a taste algorithm (e.g., users who liked the specific media preview 330 will also like this other media preview 330.)
   Social networking system 160 may then combine the information above in order to determine a coefficient associated with the user for each media preview 330. For example, consider a scenario in which a query of social graph 200 for the specific media preview 330 yielded the following results:
the number of friends of the user who have liked the specific media preview 330=5
the total number of users of social networking system 160 who have liked the specific media preview 330=1000
the number of friends of the user who have viewed the specific media preview 330=2
the total number of users of social networking system 160 who have viewed the specific media preview 330=250
   The combination of these example results would yield a coefficient of 5+1000+2+250=1257 for this media preview 330 for the user. Social networking system 160 then performs similar calculations in order to determine coefficients of other media previews 330 for the user. In certain embodiments, the resulting coefficients of all media previews 330 are then ranked for the user. A predetermined number of the top-ranked media previews 330 may then be presented to the user as recommended media content 420 in media preview landing page 410.

As discussed above, a taste algorithm may be utilized by social networking system 160 to determine recommended media content 420. For example, social networking system 160 may first determine first media previews 330 that a user watched, liked, or otherwise interacted with on social networking system 160. In some embodiments, the first media previews 330 may be determined using social graph 200. Once the first media previews 330 have been determined, social networking system 160 may then search social graph 200 to determine other users or friends of the user who also watched, liked, or otherwise interacted with the first media previews 330 on social networking system 160. Social networking system 160 may then search social graph 200 for second media previews 330 that the determined users or friends watched, liked, or otherwise interacted with on social networking system 160. The determined second media previews 330 may then be recommended to the user as recommended media content 420. In some embodiments, weighting factors may be utilized in determining what media previews 330 to recommend to a user. For example, second media previews 330 viewed by a user's friends may have a higher weight in determining recommendations for a user than second media previews 330 viewed by users who are not friends.

As an example for illustrative purposes only, consider a scenario where a first user has liked the media preview 330 for “Garage Talk” in the past. Social networking system 160 may query social graph 200 in order to determine other users or friends of the first user who have also liked the media preview 330 for “Garage Talk.” For example, social networking system 160 may determine that Friend A and User B also liked the media preview 330 for “Garage Talk.” Social networking system 160 may then query social graph 200 for other media previews 330 liked by the other users or friends who also liked the media preview 330 for “Garage Talk.” For example, social networking system 160 may determine that Friend A and User B, who liked the media preview 330 for “Garage Talk,” also liked the media previews 330 for “Shop Journal” and “Cars Galore.” Social networking system 160 may then display media previews 330 for “Shop Journal” and “Cars Galore” as recommended media content 420 to the first user. If, for example, Friend A liked the media preview 330 for “Shop Journal” and User B (who is not a friend of the first user) liked the media preview 330 for “Cars Galore,” then the media preview 330 for “Shop Journal” may appear higher in media preview landing page 410 than the media preview 330 for “Shop Journal.”

In some embodiments, social networking system 160 may cross-reference the actors or the people who were involved in making a particular program in determining what media previews 330 to display in media preview landing page 410. For example, social networking system 160 may access an external database such as the Internet Movie Database (IMDb) in order to determine the actors, producers, writers, etc. of a particular show associated with a media preview 330 liked or watched by a user or the connections of the user. Social networking system 160 may then cross-reference the determined information with other shows in order to determine other shows that the actors, producers, writers, etc. were also involved with. Media previews 330 for the other shows may then be displayed in media preview landing page 410. As an example for illustrative purposes only, consider a scenario where a friend of a user likes a media preview 330 that features Actors A and B. Social networking system 160 may recommend a media preview 330 for Show A to the user if it determines that user likes Actor B. That is, because both the user and the friend like actors that are in a particular show, social networking system 160 may recommend that user and the friend view the same media preview 330.

In certain embodiments, social networking system 160 may determine trending media previews 330 or their associated media content to display as recommended media content 420 to a user. For example, social networking system 160 may analyze posts, likes, or any other interaction with social networking system 160 in order to determine media previews 330 that are trending. Media previews 330 that are trending may be, for example, media previews 330 or their associated full-length media content that have received the most “likes” or views within a predetermined period. Social networking system 160 may then include one or more trending media previews 330 as recommended media content 420.

In certain embodiments, social-networking system 160 may collect metrics regarding user views of media previews 330 and provide the metrics, subject to user privacy settings, to entities such as TV networks and movie studios. For example, social-networking system 160 may determine using social graph 200 that ten thousand users have viewed a media preview 330 that is a trailer for an upcoming movie. Social-networking system 160 may provide this data, subject to user privacy settings, to the movie studio that produced the movie. In some embodiments, the data may be provided for a fee.

As mentioned above, some embodiments provide user selectable option 350 for purchasing tickets for full-length media associated with a media preview 330. For example, user selectable option 350 may be provided next to a media preview 330 that is a trailer for a movie that allows the user to purchase tickets to view the movie in a theater. In some embodiments, selecting the user selectable option 350 to purchase tickets may allow the user to directly purchase the tickets from media preview landing page 410. In some embodiments, selecting the user selectable option 350 to purchase tickets may launch or otherwise direct the user to an app or webpage of a third-party ticket provider such as FANDANGO or MOVIETICKETS.COM.

In some embodiments, stories may be generated by users' actions related to media previews 330, subject to user privacy settings. For example, stories may be generated based on a user liking (e.g., “User A likes this preview”), sharing, commenting on, or watching media preview 330 (e.g., “User A watched this preview”). In addition, stores may be generated by a user indicating that he wishes to see full-length media associated with media preview 330 (e.g., “User A wants to see this movie”), that he has seen full-length media associated with media preview 330 (e.g., “User A saw this movie”), that he is going to see full-length media associated with media preview 330 (e.g., “User A is going to see this movie”), that he has pre-purchased tickets to see full-length media associated with media preview 330 (e.g., “User A pre-purchased tickets for this movie at Cinema 8”), or that he has bought tickets to see full-length media associated with media preview 330 (e.g., “User A is going to see this movie at Cinema 8 with Friend B and 3 others”).

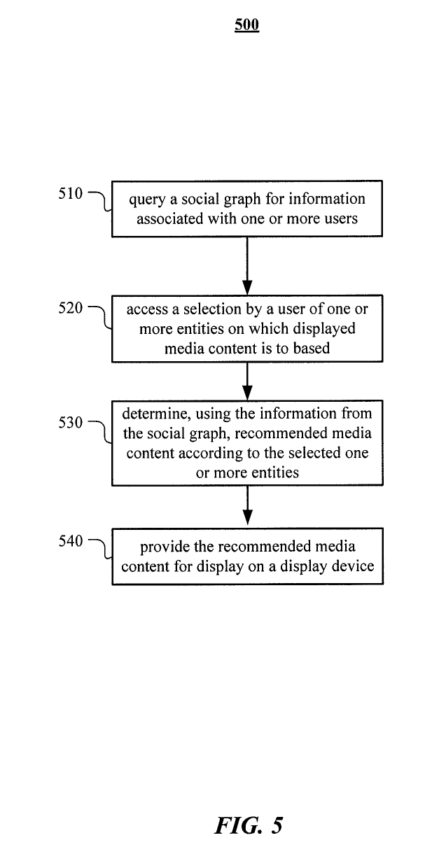

FIG. 5 illustrates an example method 500 for providing media previews. The method may begin at step 510, where a social graph of a social-networking system is queried for information associated with one or more users of the social-networking system. In some embodiments, the social-networking system is social-networking system 160 and the social graph is social graph 200 described above. In some embodiments, the social graph includes multiple nodes and edges connecting the nodes. The nodes include user nodes that are each associated with a particular user of the social-networking system. In some embodiments, the information includes stories, posts, messages, actions corresponding to a particular piece of media content, “liking” a particular content object, or any other action captured in the social graph.

In step 520, a selection by a user of one or more entities on which displayed media content is to be based is accessed. In some embodiments, the selection is user filter selection 430 described above. In some embodiments, the one or more entities are the user, friends of the user, or all users of the social-networking system.

In step 530, recommended media content for the selected one or more entities of step 520 is determined using the information from the social graph of step 510. In some embodiments, the recommended media content is recommended media content 420 described above and includes a media preview 330. In some embodiments, the recommended media content is a preview of a movie, a preview of a television show, or a preview of a game. In some embodiments, the recommended media content is based on social coefficients that indicate a ranking of particular media content. In some embodiments, the social coefficients are based at least in part on one or more of a number of friends within the social-networking system who have “liked” the particular media content, a total number of users within the social-networking system who have “liked” the particular media content, a number of friends within the social-networking system who have watched the particular media content, or a total number of users within the social-networking system who have watched the particular media content.

In step 540, the recommended media content determined in step 530 is provided for display on a display device. In some embodiments, the recommended media content is displayed in a media preview landing page such as media preview landing page 410. In some embodiments, the recommended media content is filtered according to a user selection of a type of media content to display. In some embodiments, the type of media includes movies, TV shows, or games. In some embodiments, social content from the social graph of step 510 is displayed proximate to the recommended media content on the display device. In some embodiments, the social content includes one or more of an indication of a number of other users of the social-networking system who have viewed the recommended media content, an indication of a number of other users of the social-networking system who have “liked” the recommended media content, an indication of a number of other users of the social-networking system who have shared the recommended media content, an indication of a number of comments about the recommended media content, or a facepile. In some embodiments, one or more user selectable options are provided for display with the recommended media content. The user selectable options may include one or more of an option to “like” the displayed recommended media content, an option to comment on the displayed recommended media content, an option to share the displayed recommended media content, an option to indicate that the user viewed full-length media content associated with the recommended media content, an option to indicate that the user desires to view full-length media content associated with the recommended media content, an option to indicate that the user is planning to view full-length media content associated with the recommended media content, or an option to purchase one or more tickets to view full-length media content associated with the recommended media content.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

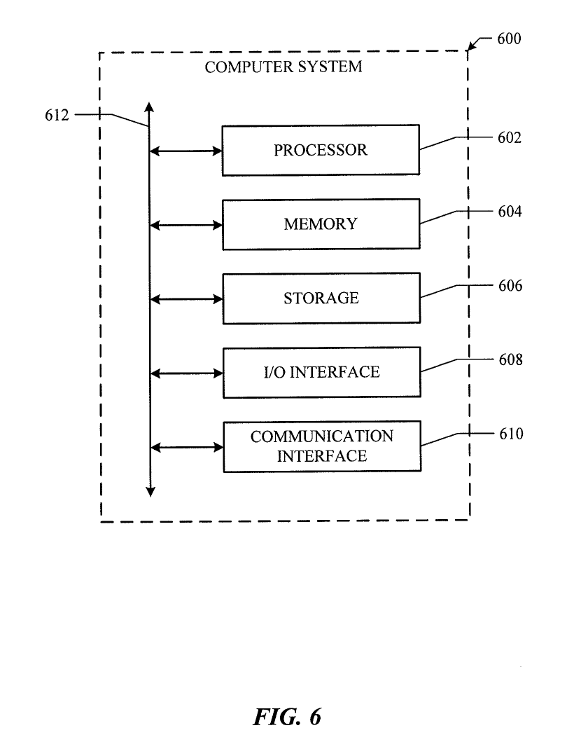

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by one or more computer systems of a social-networking system, querying a social graph of the social-networking system for information associated with one or more users of the social-networking system, the social graph comprising a plurality of nodes and edges connecting the nodes, the nodes comprising user nodes that are each associated with a particular user of the social-networking system;
by the one or more computer systems of the social-networking system, accessing a selection by a user of one or more entities on which displayed media content is to be based;
by the one or more computer systems of the social-networking system, determining, using the information from the social graph, recommended media content according to the selected one or more entities; and
by the one or more computer systems of the social-networking system, providing the recommended media content for display on a display device.

2. The method of claim 1, wherein the one or more entities comprises one of:
the user;
friends of the user; or
all users of the social-networking system.

3. The method of claim 1, further comprising:
by the one or more computer systems of the social-networking system, accessing a user selection of a type of media content to display; and
by the one or more computer systems of the social-networking system, filtering the recommended media content according to the selected type of media;
wherein the type of media comprises one of:
movies;
television shows; or
games.

4. The method of claim 1, wherein the recommended media content comprises one or more of:
a preview of a movie;
a preview of a television show; or
a preview of a game.

5. The method of claim 1, wherein the information from the social graph associated comprises one or more of:
stories;
posts;
messages;
actions corresponding to watching a particular piece of media content; or
“liking” a particular content object.

6. The method of claim 1, further comprising, by the one or more computer systems of the social-networking system:
querying the social graph of the social-networking system for social content associated with the recommended media content; and
providing the social content associated with the recommended media content for display proximate to the recommended media content on the display device.

7. The method of claim 6, wherein the social content associated with the recommended media content comprises one or more of:
an indication of a number of other users of the social-networking system who have viewed the recommended media content;
an indication of a number of other users of the social-networking system who have “liked” the recommended media content;
an indication of a number of other users of the social-networking system who have shared the recommended media content;
an indication of a number of comments about the recommended media content; or
a facepile.

8. The method of claim 1, further comprising determining, by the one or more computer systems of the social-networking system, a plurality of social coefficients, wherein:
each social coefficient indicates a ranking of particular media content; and
the recommended media content is determined using the determined social coefficients.

9. The method of claim 8, wherein the social coefficients are based at least in part on one or more of:
a number of friends within the social-networking system who have “liked” the particular media content;
a total number of users within the social-networking system who have “liked” the particular media content;
a number of friends within the social-networking system who have watched the particular media content; or
a total number of users within the social-networking system who have watched the particular media content.

10. The method of claim 1, further comprising, by the one or more computer systems of the social-networking system, providing one or more sponsored items for display with the recommended media content.

11. The method of claim 1, further comprising, by the one or more computer systems of the social-networking system, providing one or more user selectable options for display with the recommended media content, the user selectable options comprising one of:
an option to “like” the displayed recommended media content;
an option to comment on the displayed recommended media content;
an option to share the displayed recommended media content;
an option to indicate that the user viewed full-length media content associated with the recommended media content;
an option to indicate that the user desires to view full-length media content associated with the recommended media content;
an option to indicate that the user is planning to view full-length media content associated with the recommended media content; or
an option to purchase one or more tickets to view full-length media content associated with the recommended media content.

12. One or more computer-readable non-transitory storage media in one or more computing systems, the media embodying logic that is operable when executed to:
query a social graph of the social-networking system for information associated with one or more users of the social-networking system, the social graph comprising a plurality of nodes and edges connecting the nodes, the nodes comprising user nodes that are each associated with a particular user of the social-networking system;
access a selection by a user of one or more entities on which displayed media content is to be based;
determine using the information from the social graph, recommended media content according to the selected one or more entities; and
provide the recommended media content for display on a display device.

13. The media of claim 12, wherein the one or more entities comprises one of:
the user;
friends of the user; or
all users of the social-networking system.

14. The media of claim 12, wherein the recommended media content comprises one or more of:
a preview of a movie;
a preview of a television show; or
a preview of a game.

15. The media of claim 12, the logic further operable to:
query the social graph of the social-networking system for social content associated with the recommended media content; and
provide the social content associated with the recommended media content for display proximate to the recommended media content on the display device;
wherein the social content comprises one or more of:
an indication of a number of other users of the social-networking system who have viewed the recommended media content;
an indication of a number of other users of the social-networking system who have “liked” the recommended media content;
an indication of a number of other users of the social-networking system who have shared the recommended media content;
an indication of a number of comments about the recommended media content; or
a facepile.

16. The media of claim 12, the logic further operable to provide one or more user selectable options for display with the recommended media content, the user selectable options comprising one of:
an option to “like” the displayed recommended media content;
an option to comment on the displayed recommended media content;
an option to share the displayed recommended media content;
an option to indicate that the user viewed full-length media content associated with the recommended media content;
an option to indicate that the user desires to view full-length media content associated with the recommended media content;
an option to indicate that the user is planning to view full-length media content associated with the recommended media content; or
an option to purchase one or more tickets to view full-length media content associated with the recommended media content.

17. A system comprising:
one or more processors; and
a memory coupled to the processors comprising instructions executable by the processors, the processors being operable when executing the instructions to:
query a social graph of the social-networking system for information associated with one or more users of the social-networking system, the social graph comprising a plurality of nodes and edges connecting the nodes, the nodes comprising user nodes that are each associated with a particular user of the social-networking system;
access a selection by a user of one or more entities on which displayed media content is to be based;
determine using the information from the social graph, recommended media content according to the selected one or more entities; and
provide the recommended media content for display on a display device.

18. The system of claim 17, wherein:
the one or more entities comprises one of:
the user;
friends of the user; or
all users of the social-networking system; and
the recommended media content comprises one or more of:
a preview of a movie;
a preview of a television show; or
a preview of a game.

19. The system of claim 17, wherein the processors are further operable when executing the instructions to:
query the social graph of the social-networking system for social content associated with the recommended media content; and
provide the social content associated with the recommended media content for display proximate to the recommended media content on the display device;
wherein the social content comprises one or more of:
an indication of a number of other users of the social-networking system who have viewed the recommended media content;
an indication of a number of other users of the social-networking system who have “liked” the recommended media content;
an indication of a number of other users of the social-networking system who have shared the recommended media content; or
an indication of a number of comments about the recommended media content; or
a facepile.

20. The system of claim 17, wherein the processors are further operable when executing the instructions to provide one or more user selectable options for display with the recommended media content, the user selectable options comprising one of:
an option to “like” the displayed recommended media content;
an option to comment on the displayed recommended media content;
an option to share the displayed recommended media content;
an option to indicate that the user viewed full-length media content associated with the recommended media content;
an option to indicate that the user desires to view full-length media content associated with the recommended media content;
an option to indicate that the user is planning to view full-length media content associated with the recommended media content; or
an option to purchase one or more tickets to view full-length media content associated with the recommended media content.
